(19) United States
(12) Patent Application Publication
(10) Pub. No.: US 2026/0044804 A1
(43) Pub. Date: Feb. 12, 2026

(54) SYSTEMS AND METHODS FOR GENERATING INSIGHTS AND RECOMMENDATIONS TO REDUCE WASTE IN RETAIL STORES

(71) Applicant: Walmart Apollo, LLC, Bentonville, AR (US)

(72) Inventors: Saikrishna Pallerla, Bengaluru (IN); Hemant Kumar Sharma, Jaipur (IN); Somedip Karmakar, Bengaluru (IN); Subhasish Misra, Whitefield (IN); Swati Kirti, Bellevue, WA (US); Seth Ryan Vannaman, Bentonville, AR (US); Thomas Nathan Teruel, Midland, TX (US); David Anthony Orwick, Shawnee, KS (US); Dhaval Sureshchandra Gandhi, Bangalore (IN); Rajarshi Dasgupta, HSR Layout (IN); Sandeep Kumar H R, Bangalore North (IN)

(21) Appl. No.: 18/797,719

(22) Filed: Aug. 8, 2024

(51) Int. Cl. G06Q 10/0637; G06Q 10/0639; G06Q 10/087

(52) U.S. Cl. CPC G06Q 10/06375; G06Q 10/06393; G06Q 10/087

(57) ABSTRACT

Systems and methods for generating insights and recommendations to reduce waste in retail stores are disclosed. In some embodiments, a disclosed method includes: obtaining waste data of a plurality of stores; selecting, from the plurality of stores, at least one store based on the waste data; generating, based on the waste data and at least one machine learning model, recommendation data for the at least one store to take at least one action to reduce waste; and providing the recommendation data to the at least one store.

### TECHNICAL FIELD

This application relates generally to waste management and optimization and, more particularly, to systems and methods for generating insights and recommendations to reduce waste in retail stores.

### BACKGROUND

Waste management is a ubiquitous challenge globally, especially for retailers. A retail waste may lead to a loss of a substantial percentage of total sales. It is critical for associates in retail stores to timely know whether the retail waste is high and understand whether there is any store operation that can be taken to reduce the waste. But there is no existing method to provide a clear guidance or steps to be followed for efficient retail waste management.

### SUMMARY

The embodiments described herein are directed to systems and methods for generating insights and recommendations to reduce waste in retail stores.

In various embodiments, a system including a non-transitory memory configured to store instructions thereon and at least one processor is disclosed. The at least one processor is operatively coupled to the non-transitory memory and configured to read the instructions to: obtain waste data of a plurality of stores; select, from the plurality of stores, at least one store based on the waste data; generate, based on the waste data and at least one machine learning model, recommendation data for the at least one store to take at least one action to reduce waste; and provide the recommendation data to the at least one store.

In various embodiments, a computer-implemented method is disclosed. The computer-implemented method includes: obtaining waste data of a plurality of stores; selecting, from the plurality of stores, at least one store based on the waste data; generating, based on the waste data and at least one machine learning model, recommendation data for the at least one store to take at least one action to reduce waste; and providing the recommendation data to the at least one store.

In various embodiments, a non-transitory computer readable medium having instructions stored thereon is disclosed. The instructions, when executed by at least one processor, cause at least one device to perform operations including: obtaining waste data of a plurality of stores; selecting, from the plurality of stores, at least one store based on the waste data; generating, based on the waste data and at least one machine learning model, recommendation data for the at least one store to take at least one action to reduce waste; and providing the recommendation data to the at least one store.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for generating insights and recommendations to reduce waste in retail stores, in accordance with some embodiments of the present teaching;

FIG. 2 is a block diagram of a waste reduction computing device, in accordance with some embodiments of the present teaching;

FIG. 3 is a block diagram illustrating various portions of a system for generating insights and recommendations to reduce waste in retail stores, in accordance with some embodiments of the present teaching;

FIG. 4 illustrates an exemplary process for generating and presenting insights and recommendations for waste reduction, in accordance with some embodiments of the present teaching;

FIG. 5 illustrates an exemplary process for anomaly detection, in accordance with some embodiments of the present teaching;

FIG. 6 illustrates an exemplary causal graph between waste and its related variables, in accordance with some embodiments of the present teaching;

FIG. 7 illustrates an exemplary process for generating recommendation data based on casual inference, in accordance with some embodiments of the present teaching;

FIG. 8 illustrates an exemplary causal machine learning model, in accordance with some embodiments of the present teaching;

FIG. 9 shows a flowchart illustrating an exemplary method for generating insights and recommendations to reduce waste in retail stores, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

To reduce or minimize retail waste in stores, it is critical for associates in retail stores to timely know whether the retail waste is high and understand whether there is any store operation that can be taken to reduce the waste. One objective of various embodiments in the present teaching is to provide a system for generating insights and recommendations to reduce waste in retail stores. The system can track waste in the stores, identify anomalous patterns, diagnose the reasons and drivers that led to the waste, and recommend prescriptive actions to reduce or minimize the waste. In some embodiments, the system utilizes various tools and techniques like dashboard, anomaly detection, changepoint analysis, causal machine learning, generative artificial intelligence.

In some embodiments, the system provides a waste dashboard to show dynamic rankings in terms of multiple waste key performance indicators (KPIs), e.g. waste to sales, customer value proposition (CVP) based markdown sales to waste etc., along with tickers depicting change in rank from previous timeframe and waste distribution for a selected granularity (e.g. region, market, or stores). The system can detect changes in patterns in the waste KPIs and provides timely insights to associates or business owners, via the dashboard or a notification message. For example, after noticing a potential change in trend from usual behavior, the system can indicate some preventive actions to be taken immediately by identifying if any change in strategy or initiative taken had interacting effects (e.g. in a negative way) on waste KPIs.

In some embodiments, the system utilizes anomaly detection and changepoint analysis for efficiently understanding waste insights and narrowing down the options for waste reduction by determining poorly performing stores and/or items in terms of multiple waste KPIs. Further, the system can generate store clusters, create a profile for each cluster, and provide inter and intra cluster recommendations at different levels (e.g. store, department, category, item, etc.).

In some embodiments, the system utilizes causal machine learning techniques to identify causal relationships between drivers and waste KPIs, estimate the treatment effect of changes to drivers on various segments of waste data to freeze on providing recommended actions only to those segments that benefit most from them. In addition, the system generates recommendations powered by generative artificial intelligence to provide insight into the effect of drivers of waste and recommended actions which can be leveraged by the store managers and associates to strategize waste reduction.

The disclosed system provides a seamless solution with multiple modules, each of which consumes output of previous modules, including: diagnosing and detecting changes, mapping them to understand what key events or product decisions taken caused these changes, using the key drivers identified to establish causal relationships and generate insights and recommended actions to be taken at various levels (e.g. store, department, category, item, etc.), and quantifying the potential savings of those actions.

Furthermore, in the following, various embodiments are described with respect to systems and methods for generating insights and recommendations to reduce waste in retail stores are disclosed. In some embodiments, a disclosed method includes: obtaining waste data of a plurality of stores; selecting, from the plurality of stores, at least one store based on the waste data; generating, based on the waste data and at least one machine learning model, recommendation data for the at least one store to take at least one action to reduce waste; and providing the recommendation data to the at least one store.

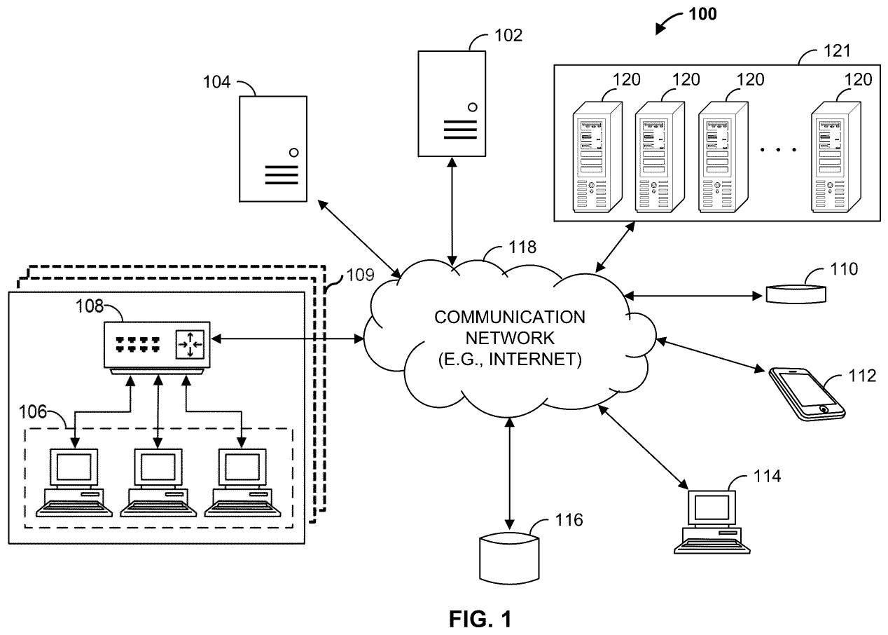

Turning to the drawings, FIG. 1 is a network environment 100 configured for generating insights and recommendations to reduce waste in retail stores, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a waste reduction computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The waste reduction computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the waste reduction computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the waste reduction computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the waste reduction computing device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at one or more departments 109 of a corporation. In some examples, the departments 109 correspond to different services, product categories, corporate functions, retail departments, stores, channels and/or platforms of a retailer. In some examples, different departments 109 may execute different applications that are integrated using clusters and topics via a data service platform.

The workstation(s) 106 can communicate with the waste reduction computing device 102 over the communication network 118. The workstation(s) 106 may send data to, and receive data from, the waste reduction computing device 102. For example, the workstation(s) 106 may transmit data identifying transactions, inventory, supply chain data or waste data at the one or more departments 109 to the waste reduction computing device 102. The workstation(s) 106 may also transmit other data related to the one or more departments 109 to the waste reduction computing device 102.

Although FIG. 1 illustrates three user computing devices 110, 112, 114, the network environment 100 can include any number of user computing devices 110, 112, 114. Similarly, the network environment 100 can include any number of the waste reduction computing devices 102, the processing devices 120, the workstations 106, the departments 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the departments 109 over the communication network 118. For example, one of the multiple user computing devices 110, 112, 114 may be operable to view, access, and interact with a website, such as a retailer's website, hosted by a server in an e-commerce department 109. The server may transmit user session data related to a customer's activity (e.g., interactions) on the website. For example, a customer may operate one of the user computing devices 110, 112, 114 to initiate a web browser that is directed to the website. The customer may, via the web browser, search for items, view item advertisements for items displayed on the website, and click on item advertisements and/or items in the search result, for example. The website may capture these activities as user session data, and transmit the user session data to the waste reduction computing device 102 over the communication network 118. The website may also allow the operator to add one or more of the items to an online shopping cart, and allow the customer to perform a “checkout” of the shopping cart to purchase the items. In some examples, the waste reduction computing device 102 obtains metadata regarding purchase data and user interaction data exchanged between the departments 109.

In some embodiments, an associate (or a manager or a store owner) of a retail store of a retailer may operate one of the user computing devices 110, 112, 114 to access an application programming interface (API) hosted by the server 104. The associate may, via the API, view: waste data related to the retail store compared to other retail stores of the retailer, insight data indicating key drivers of the waste generated at the store, and recommendation data indicating one or more actions to be taken to reduce the waste at the store. The associate may provide feedback data to the waste reduction computing device 102, to indicate an effectiveness of these actions. The associate may perform these actions and then provide a feedback, or directly provide a feedback indicating that these actions are not applicable with corresponding reasons. The API may capture these activities of the associate as user session data or as they are, and transmit these activities to the waste reduction computing device 102 over the communication network 118.

In some examples, the waste reduction computing device 102 may obtain waste data of a plurality of stores, and present the waste data of the plurality of stores via a user interface or website hosted by the server 104 to associates of the plurality of stores. The waste reduction computing device 102 may select, from the plurality of stores, at least one store based on the waste data, and execute one or more models (e.g., programs or algorithms), such as a machine learning model, deep learning model, statistical model, etc., to generate insight data based on the waste data. The waste reduction computing device 102 may rank the insight data and present the ranked insight data via the user interface or website to associates of the at least one store. Further, the waste reduction computing device 102 can create a causal graph based on the waste data to show a relationship between known treatment variables, outcome variables, and confounding variables related to waste management and markdown efficiency, and input the causal graph to a causal machine learning model to determine key waste drivers and generate recommendation data based on the key waste drivers. The recommendation data indicates at least one action to be taken at the at least one store to reduce waste, and may be presented to associates of the at least one store via the user interface, the website, alerts and/or notifications. The waste reduction computing device 102 may receive feedback data from the associates of the at least one store regarding effectiveness of the at least one action for waste reduction, and generate and provide updated recommendation data to the associates based on the feedback.

In some embodiments, the waste reduction computing device 102 is further operable to communicate with the database 116 over the communication network 118. For example, the waste reduction computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the waste reduction computing device 102, in some examples, the database 116 can be a local storage device, such as a hard drive, a non-volatile memory, or a USB stick. For example, the waste reduction computing device 102 may store user request and instruction data received from the server 104 in the database 116. The waste reduction computing device 102 may receive store related data from a physical store 109 and save them in the database 116. The waste reduction computing device 102 may also receive from an e-commerce store 109 user session data identifying events associated with browsing sessions, and may store the user session data in the database 116.

In some examples, the waste reduction computing device 102 generates and/or updates different models (e.g., machine learning models, deep learning models, statistical models, algorithms, etc.) for generating insights and recommendations to reduce waste in retail stores. The waste reduction computing device 102 may generate training data for the models based on data including but not limited to: historical waste KPI data, store features, item features, historical waste risk scores computed for the stores, historical or labelled anomaly data, historical or labelled insight data, historical recommendation data, and historical feedback data. The waste reduction computing device 102 trains the models based on their corresponding training data, and stores the models in a database, such as in the database 116 (e.g., a cloud storage). The models, when executed by the waste reduction computing device 102, allow the waste reduction computing device 102 to generate insights and recommendations for waste reduction or minimization in retail stores.

In some examples, the waste reduction computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the waste reduction computing device 102 may generate insights and recommendations for waste reduction or minimization in retail stores.

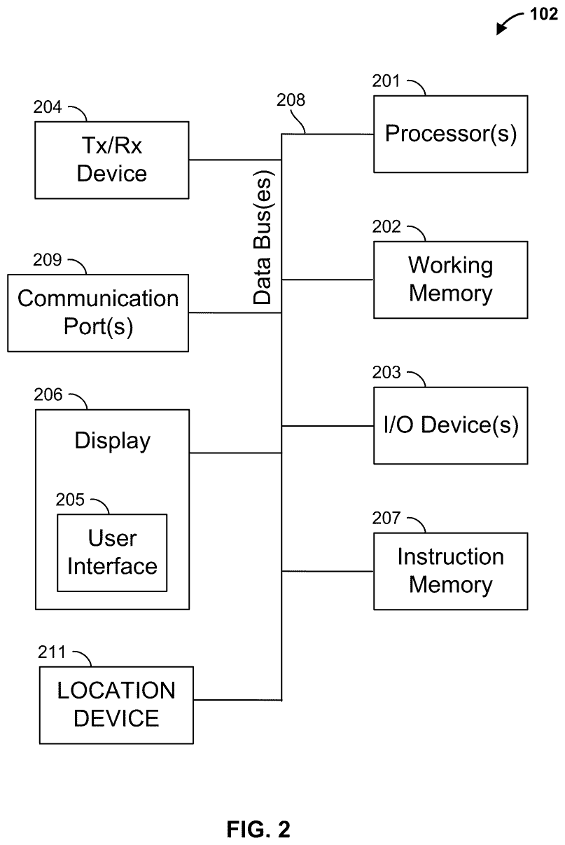

FIG. 2 illustrates a block diagram of a waste reduction computing device, e.g. the waste reduction computing device 102 of FIG. 1, in accordance with some embodiments of the present teaching. In some embodiments, each of the waste reduction computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the waste reduction computing device 102 can be combined, omitted, and/or replicated. In addition, it will be appreciated that additional elements other than those illustrated in FIG. 2 can be added to the waste reduction computing device 102.

As shown in FIG. 2, the waste reduction computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the waste reduction computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the waste reduction computing device 102 can include a single memory unit configured to operate as both instruction memory and working memory. Further, although embodiments are discussed herein including non-volatile memory, it will be appreciated that the waste reduction computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the waste reduction computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the waste reduction computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the waste reduction computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the waste reduction computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the waste reduction computing device 102 may determine a local geographical area (e.g., town, city, state, etc.) of its position.

In some embodiments, the waste reduction computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

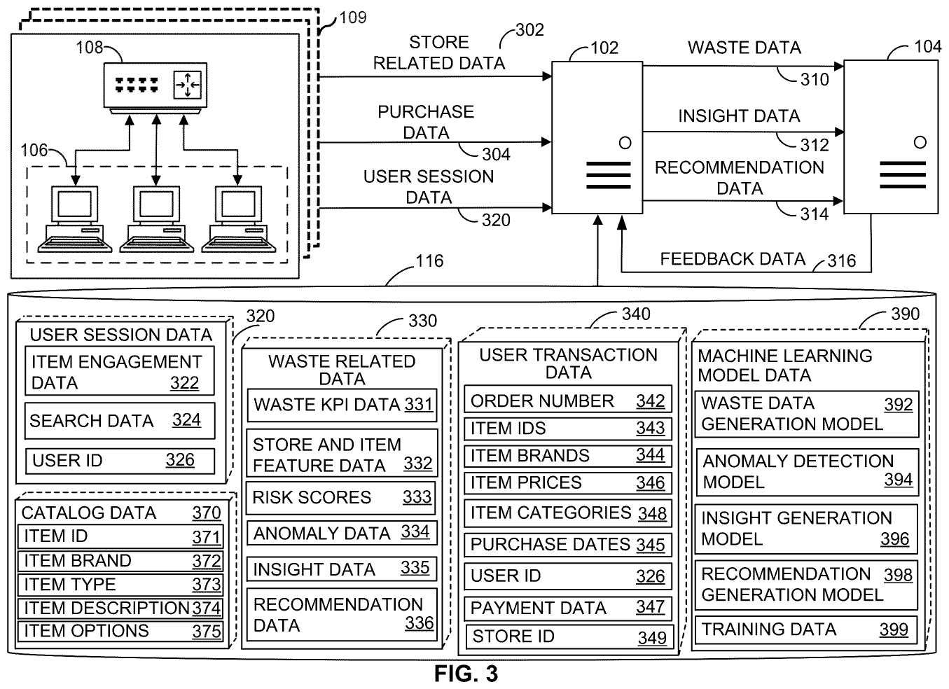

FIG. 3 is a block diagram illustrating various portions of a system for generating insights and recommendations to reduce waste in retail stores, e.g. the system shown in the network environment 100 of FIG. 1, in accordance with some embodiments of the present teaching. As indicated in FIG. 3, the waste reduction computing device 102 may receive user session data 320 from the departments 109 (e.g. a retail store 109), and store the user session data 320 in the database 116. The user session data 320 may identify, for each user (e.g., customer, engineer or manager), data related to that user's browsing session, such as when browsing a retailer's webpage or API. In some embodiments, the system may not utilize all of the components and data shown in FIG. 3 for generating insights and recommendations to reduce waste in retail stores.

In some examples, the user session data 320 may include item engagement data 322, search data 324, and user ID 326 (e.g., a customer ID, manager ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The waste reduction computing device 102 may also receive purchase data 304 from the store 109, which identifies and characterizes one or more purchases, such as purchases made by the user and other users in the store 109 or via a retailer's website associated with the store 109. The waste reduction computing device 102 may also receive store related data 302 from the one or more stores 109, which identifies and characterizes transactions, inventory and other retail related data in those stores 109.

The store related data 302 and the purchase data 304 may be parsed to generate user transaction data 340. The waste reduction computing device 102 may obtain metadata regarding the user transaction data 340 exchanged among sub-systems of the system. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding online orders, and store ID 349 for the corresponding in-store purchase, or for the pickup store or shipping—from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some embodiments, the database 116 may further store waste related data 330, which may identify related data for computing, monitoring and reducing waste at the stores. The waste related data 330 may identify: waste KPI data 331 indicating KPI measurements or metrics (e.g. waste to sales, markdown sales to waste) for waste management of the stores, store and item feature data 332 indicating store features and item features related to waste management, risk scores 333 each indicating a waste risk for a corresponding store, anomaly data 334 indicating data related to detected anomalous stores and/or anomalous items, insight data 335 indicating insights (e.g. root causes, reasons, impact factors) of detected anomalies, and recommendation data 336 indicating recommended actions (e.g. with due dates and expected effects) for waste reduction at the stores.

The database 116 may also store machine learning model data 390 identifying and characterizing one or more models and related data for generating insights and recommendations to reduce waste in retail stores. For example, the machine learning model data 390 may include: a waste data generation model 392, an anomaly detection model 394, an insight generation model 396, a recommendation generation model 398 and training data 399. In various embodiments, the machine learning model data 390 includes any number of the waste data generation models 392, the anomaly detection models 394, the insight generation models 396, and the recommendation generation models 398.

The waste data generation model 392 in this example can be used to collect and/or generate waste data of a plurality of stores. The waste data may include a plurality of measurements related to waste management and markdown efficiency at each of the plurality of stores. The waste data generation model 392 may be used to compute a waste risk score for each respective store of the plurality of stores based on a weighted combination of the plurality of measurements at the respective store. The system can rank the plurality of stores based on their respective waste risk scores, and select, from the plurality of stores, a subset of stores having highest waste risk scores based on the ranking to perform waste reduction recommendation.

The anomaly detection model 394 can be used to identify anomalous stores in the plurality of store and identify anomalous items in the anomalous stores, e.g. in terms of waste performance. In some examples, the anomaly detection model 394 includes a first machine learning model and a second machine learning model. The system can determine waste features and markdown features of the plurality of stores both at a store level and at an item level. The system may apply the first machine learning model to the waste features and the markdown features at the store level to identify a first set of anomalous stores, and apply the first machine learning model to the waste features and the markdown features at the item level to identify anomalous items in the first set of anomalous stores. Then, the system may apply the second machine learning model to the waste data to identify a second set of anomalous stores and anomalous items in the second set of anomalous stores, based on waste performance trends in the waste data over a time period.

The insight generation model 396 in this example can be used to generate or determine insight data indicating one or more factors causing the anomaly, e.g. based on results from the first machine learning model and the second machine learning model in the anomaly detection model 394. In some embodiments, the insight generation model 396 can be used to rank the insight data based on monetary value lost associated with the results from the first machine learning model and the second machine learning model, where the ranked insight data can be presented to store associates.

The recommendation generation model 398 in this example can be used to generate recommendation data for waste reduction. In some examples, the recommendation generation model 398 includes a clustering model for clustering the plurality of stores into a plurality of clusters based on store related characteristics and performances, each cluster including stores having similar characteristics and performances (e.g. similar size, location, revenue, category, inventory, items, return policy, etc.) to each other. In some examples, for each cluster: the system can compute a distribution of the stores in the cluster based on waste risk scores, identify a first list of stores having top waste risk scores in the cluster, and identify a second list of stores having top performances in the cluster. The system may use the recommendation generation model 398 to generate the recommendation data for the first list of stores based on at least one action taken by the second list of stores.

In some embodiments, the system can create a causal graph based on the waste data to show a relationship between known treatment variables, outcome variables, and confounding variables related to waste management and markdown efficiency. The recommendation generation model 398 may include a causal machine learning model used to determine key waste drivers and generate the recommendation data based on the key waste drivers, where results from the causal graph are used as input to the causal machine learning model. The recommendation generation model 398 may further be used to determine a granularity level (e.g. store, department, category, or item) for the action recommendation, and used to determine a manner (e.g. webpage, application, user interface, alert or notification) for presenting the recommendation data to associates.

In some embodiments, one or more of the waste data generation models 392, the anomaly detection models 394, the insight generation models 396, and the recommendation generation models 398 can be implemented as a machine learning model. The training data 399 may include data utilized for training one or more of the waste data generation models 392, the anomaly detection models 394, the insight generation models 396, and the recommendation generation models 398. In some examples, the training data 399 may be formed based on: waste KPI data, store and item features, waste risk scores, labelled anomaly data, anomaly insight data, and/or labelled action recommendations, obtained from either real data or synthetic data.

In some examples, the waste reduction computing device 102 generates or obtains waste data 310 for each of the stores 109, based on waste KPI measurements using the waste data generation model 392, and presents the waste data 310 to associates of the stores 109 via a user interface, e.g. a dashboard of an application or website hosted by the server 104. The waste reduction computing device 102 can generate insight data 312 using the insight generation model 396 and generate recommendation data 314 using the recommendation generation model 398, for waste reduction. The insight data 312 and the recommendation data 314 may be presented via the user interface and the server 104 as well, e.g. focusing on a subset of stores having highest waste risks. In some examples, for each store of the subset of stores, the recommendation data indicates at least one action to be taken for the store, at a store level, a department level, a category level, and/or an item level.

In some examples, the waste reduction computing device 102 obtains feedback data 316 from the associates indicating effectiveness (or applicability) of the at least one action for waste reduction. The waste reduction computing device 102 may periodically update, based on the feedback data 316, the recommendation data 314 (as well as the insight data 312) and provide the updated recommendation data 314 to the relevant stores via the user interface and the server 104.

In some embodiments, the waste reduction computing device 102 may assign one or more of the above described operations to a different processing unit or virtual machine hosted by one or more processing devices 120. Further, the waste reduction computing device 102 may obtain the outputs of the these assigned operations from the processing units, and generate the waste data 310, the insight data 312 and/or the feedback data 316 based on the outputs.

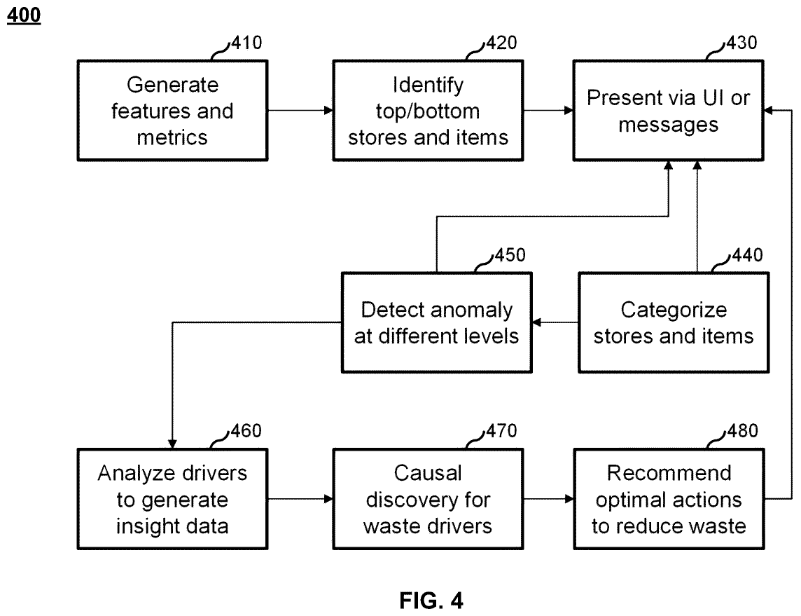

FIG. 4 illustrates an exemplary process 400 for generating and presenting insights and recommendations for waste reduction, in accordance with some embodiments of the present teaching. In some embodiments, the process 400 can be carried out by one or more computing devices, such as the waste reduction computing device 102, the server 104, and/or the cloud-based engine 121 of FIG. 1.

As shown in FIG. 4, the process 400 starts from operation 410, where features and metrics are generated for waste data monitoring. In some embodiments, the system determines various features and metrics, such as total waste, waste percentage of sales, CVP sales percentage of waste, percentage of CVP sales by markdown, lost profit value, etc., and obtain waste data of a plurality of stores according to these features and metrics. In some embodiments, the plurality of stores are associated with a same retailer, and the waste data includes a plurality of measurement results related to waste management and markdown efficiency at each of the plurality of stores. As such, performance of the stores in terms of their waste management and markdown efficiency can be tracked based on these features and metrics.

At operation 420, the system can identify top and bottom stores and items, according to the waste data. In some embodiments, the system can select, from the plurality of stores, at least one store based on the waste data. For example, the system can select, from the plurality of stores, a subset of stores based on the waste data. The system can compute a weight for each respective measurement of the plurality of measurements based on a function of variance of a distribution of the respective measurement in historical data; compute a waste risk score for each respective store of the plurality of stores based on a weighted combination of the plurality of measurements at the respective store, using the computed weights for the plurality of measurements; rank the plurality of stores based on their respective waste risk scores; and select, from the plurality of stores, the subset of stores having highest waste risk scores based on the ranking.

In some examples, the system assigns a waste risk score as a unified metric to each store based on a weighted importance combination of the above mentioned multiple individual measures (e.g. total waste, waste percentage of sales, CVP sales percentage of waste, percentage of CVP sales by markdown, lost profit value, etc.). The weights for each of the measures can be obtained as a function of variance of their distribution in the historical data. The inverse values of the variance may be calculated, and a ratio of those values versus their sum may be used as the weights for corresponding metrics in calculating the waste risk score. In some examples, these waste risk scores can be finetuned based on feedback or input from business teams and weights can be altered based on relative importance of the measures in ranking the stores' performance.

The computed waste risk scores can help identifying stores with poor performance to focus on taking proactive actions to improve their KPIs. Further, this single metric of waste risk score can act as a balanced measure which is robust enough to not mislead managers in taking unwarranted actions or cause negative effects. At the same time, the waste risk score can help store managers and associates to avoid misusing any mechanism designed to falsefully improve their ranking by adopting proxy techniques.

At operation 430, the system can present the waste data of the plurality of stores via a user interface (UI) or some messages (notifications or alerts) to associates of the plurality of stores. In some examples, the system presents a descriptive view of the stores using a store leaderboard at cross-sectional level (by department, category etc.) and at longitudinal level (over a time period) to analyze what happened in the past. In some embodiments, the top and bottom stores and items are highlighted when presenting the waste data at the operation 430. In some embodiments, the waste data presented at the operation 430 includes the waste risk scores for each store.

At operation 440, stores and items are categorized into clusters. The system may present the categorized stores and items via the UI or messages as in the operation 430. In some examples, the system can cluster the plurality of stores into a plurality of clusters based on store related characteristics and performances, each cluster including stores having similar characteristics and performances to each other. Then for each cluster: the system can compute a distribution of the stores in the cluster based on waste risk scores, identify a first list of stores having top waste risk scores in the cluster, identify a second list of stores having top performances in the cluster, and generate recommendation data for the first list of stores based on at least one action taken by the second list of stores.

At operation 450, the system detects anomaly at different levels. In some examples, the system utilizes an unsupervised machine learning model on the waste features data to identify any suspicious cases which deviate from normal behavior. This can generate a smaller subset of poorly performing stores which are concerning and require attention, and give an additional ability for identifying stores that might not show up as anomalous data points on any of the individual measures but are in fact equally bad or even worse. In some embodiments, the unsupervised machine learning model is generated based on an isolation forest model which is a multivariate anomaly detection technique, and gives an opportunity for store and regional managers to combine the ranking from individual measures along with the output of the isolation forest model to focus on waste reduction opportunities that are evident and can lead to improved efficiency. The anomaly detection can be performed at store level, at category level, and/or at item level.

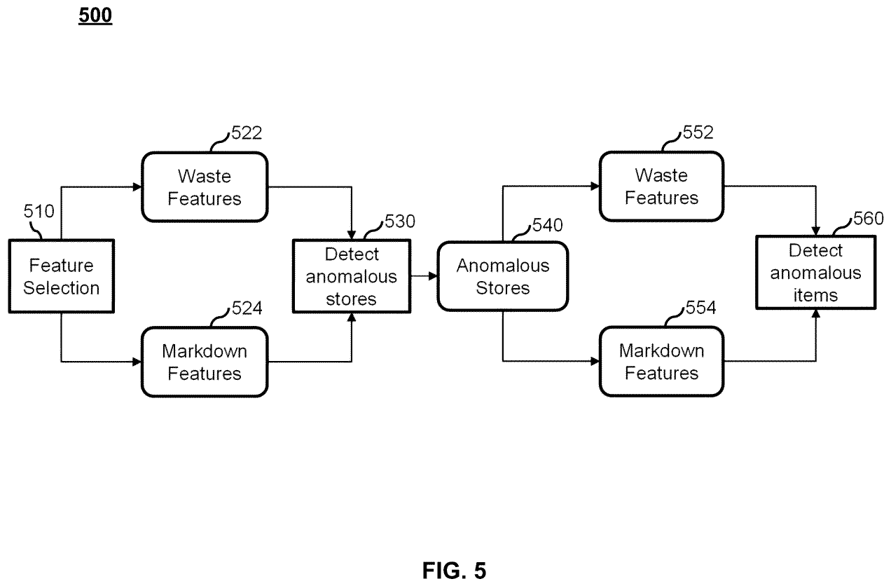

FIG. 5 illustrates an exemplary process 500 for anomaly detection, in accordance with some embodiments of the present teaching. In some embodiments, the process 500 can be implemented as part of the operation 450 in FIG. 4. In some embodiments, the process 500 can be carried out by one or more computing devices, such as the waste reduction computing device 102, the server 104, and/or the cloud-based engine 121 of FIG. 1.

As shown in FIG. 5, the process 500 starts from operation 510, where the system selects features for anomaly detection. For example, the system can determine waste features 522 and markdown features 524 of the plurality of stores at a store level. Further, the system can also determine waste features 552 and markdown features 554 of the plurality of stores at an item level.

At operation 530, the system can apply a first machine learning model to the waste features 522 and the markdown features 524 for anomaly detection at the store level. At operation 530, the output of the first machine learning model may be used to detect or identify one or more anomalous stores 540. In some examples, a markdown feature may be related to a price markdown for an item, e.g. a degree or percentage of markdown for the items, a frequency of markdown for the items, a coverage or percentage of items for the markdown, etc. In some examples, a waste feature may be related to waste generation, e.g. what kind of waste is getting generated in what departments, losses due to waste like donations or throw-aways, etc.

Then at operation 560, the system can apply the same first machine learning model to the waste features 552 and the markdown features 554 for anomaly detection at the item level. At operation 560, the system can detect or identify one or more anomalous items in the one or more anomalous stores 540 based on the output of the first machine learning model at the operation 560.

Referring back to FIG. 4, the system can also detect anomaly at a longitudinal level or over time, during the operation 450. For example, the system can apply a second machine learning model to the waste data to identify a set of anomalous stores and anomalous items in the set of anomalous stores, based on trends in the waste data over a time period. For example, at a longitudinal level, the system can analyze an anomalous behavior, e.g. drastic change in the trends of waste KPIs, using a change point detection model. In some embodiments, the anomaly detection over time is performed only within the anomalous stores detected during the process 500. In some embodiments, the anomaly detection over time is performed over all stores or a subset of stores determined during the operation 420. The system may present the detected anomaly (e.g. anomalous stores and items) via the UI or messages as in the operation 430.

In some embodiments, the system finds an intersection set of: the subset of stores determined during the operation 420, a first set of anomalous stores determined at cross-sectional level (as in the process 500) and a second set of anomalous stores determined at longitudinal level; and will only generate insight data and recommended actions for stores in the intersection set. In some embodiments, the system finds a union set of: the subset of stores determined during the operation 420, the first set of anomalous stores determined at cross-sectional level (as in the process 500) and the second set of anomalous stores determined at longitudinal level; and will generate insight data and recommended actions for all stores in the union set.

At operation 460, the system can generate insight data for waste reduction based on results from the first machine learning model and the second machine learning model applied during the operation 450. In some examples, the system can rank the insight data based on monetary value lost associated with the results from the first machine learning model and the second machine learning model; and present the ranked insight data via the UI or the messages as in the operation 430. For example, the system can generate a holistic view of critical opportunity areas by combining the results from all anomaly detections performed at the operation 450. The results are further prioritized based on a dollar value benefit lost and presented as insights on a UI dashboard. The insight data is used to indicate key drivers or factors what led to this concerning behavior and how to fix it using some actions.

At operation 470, the system performs a causal discovery in combination with a simulation of various scenarios, to estimate the impact of modifying controllable drivers that influence the waste KPIs. In some examples, the system creates a causal graph based on the waste data to show a relationship between known treatment variable, outcome variables, and confounding variables related to waste management and markdown efficiency. The confounding variables are those that could influence the target variable together with other variables. The treatment variable is an intervention variable whose effect on the outcome variable is studied.

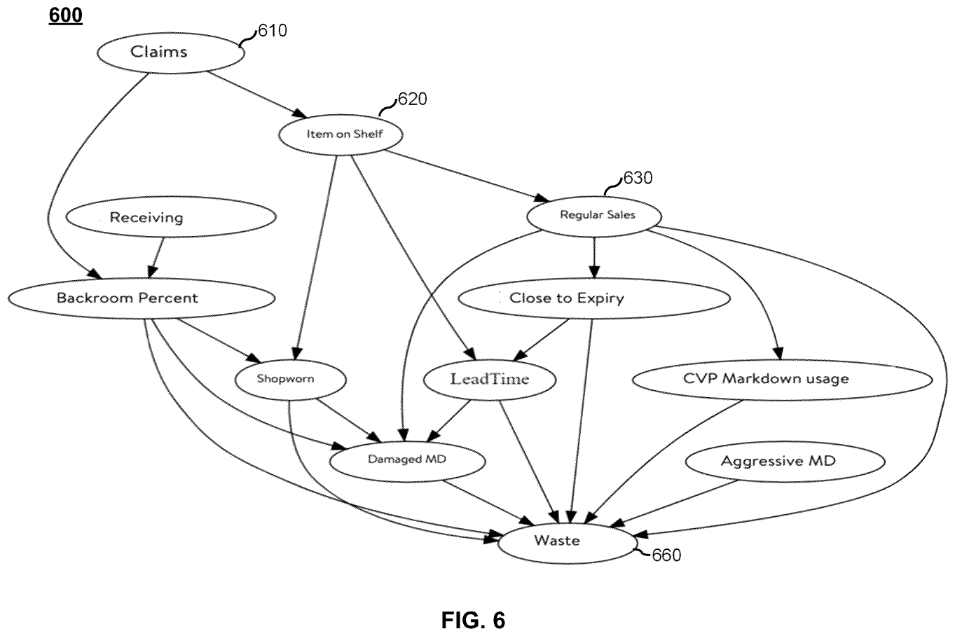

FIG. 6 illustrates an exemplary causal graph 600 between waste and its related variables, in accordance with some embodiments of the present teaching. In some embodiments, the causal graph 600 may be created and utilized during the operation 470 in FIG. 4.

As shown in FIG. 6, the causal graph 600 is built on the observed data to uncover the relationship between waste 660 and its related variables like claims 610 (items that cannot be sold e.g. due to damage or return), item on shelf 620, regular sales 630, etc. For example, a higher volume of regular sales 630 tends to have a higher waste 660, which corresponds a connection from the regular sales 630 to the higher waste 660 in the causal graph 600.

A causal graph like the causal graph 600 can capture a conditional dependence between variables and may be used as input to estimate the causal effects. For example, an increased CVP coverage of items can be a confounder that can affect both markdown sales as well as number of items markdown closer to expiry. For example, an inventory of items in the store can affect potential sales as well as throw-away waste in opposite ways.

Referring back to FIG. 4, the system can generate recommendation data at operation 480, to recommend at least one action for a high waste store to reduce waste. The at least one action may be an optimal action determined based on the waste data and at least one machine learning model. The system may present the recommendation data via the UI or messages as in the operation 430.

In some examples, the system can input the causal graph generated during the operation 470 to a causal machine learning model to determine key waste drivers and generate the recommendation data based on the key waste drivers at the operation 480. In some embodiments, the recommendation data includes context-based human readable recommended actions, based on large language models on top of the causal discovery results from the operation 470. In some embodiments, the recommended actions may include one or more of: inventory management, price markdown, promotion activity, etc. In some embodiments, the recommendation data indicates the at least one action to be taken at a store level, a department level, a category level, and/or an item level. In some embodiments, the recommendation data is presented to associates via a webpage, a user interface, alerts and/or notifications.

In some embodiments, the system can obtain feedback from the associates regarding effectiveness of the at least one action for waste reduction. In some examples, after receiving multiple recommended actions, the associates may give positive feedback to some recommended actions and give negative feedback to other recommended actions. Based on the feedback, the system can update a reward function for an agent in a reinforcement learning model to learn optimized actions through an iterative learning process. The system then generates updated recommendation data based on the optimized actions; and provides the updated recommendation data to the associates.

In some embodiments, the system provides recommendations to the associates at various levels such as store, department, category, item etc. In some examples, the recommendations are generated based on goals set by business. In some examples, the recommendations are generated based on store similarity, e.g. recommending behavior from well performing stores to similar but poorly performing stores based on different waste KPIs. For example, the recommendations could be generated by mapping a current inventory of items with their sales rate to alert associates to apply markdowns much early before expiry to minimize throw-aways, increase coverage of items put on markdown in the shelves by looking at similar stores, etc.

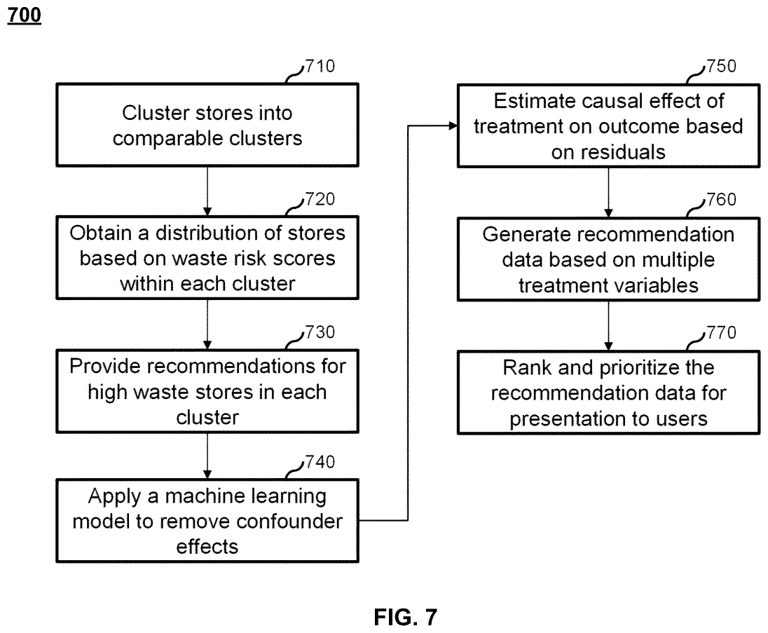

FIG. 7 illustrates an exemplary process 700 for generating recommendation data based on casual inference, in accordance with some embodiments of the present teaching. In some embodiments, the process 700 can be implemented as part of the process 600 in FIG. 6. In some embodiments, the process 700 can be carried out by one or more computing devices, such as the waste reduction computing device 102, the server 104, and/or the cloud-based engine 121 of FIG. 1.

As shown in FIG. 7, the process 700 starts from operation 710, where a plurality of stores are clustered into comparable clusters or similar cohorts. The system can study the cluster profile of these cohorts to provide a lot of initial insights. At operation 720, the system generates and obtains a distribution of stores based on waste risk scores within each cluster. For example, the system can overlay the similar stores identified using clustering with waste risk zones previously calculated to generate the store distribution. In some examples, a plurality of waste risk zones are defined, where each waste risk zone corresponds to a respective value range for the waste risk scores previously computed for the stores in each cluster. Each store in a cluster is assigned to a respective waste risk zone based on its waste risk score, to generate the store distribution.

At operation 730, the system can provide intra and/or inter cluster recommendations based on waste KPIs. For example, for each cluster, the system can provide recommendations for stores with high waste risk scores based on comparable top performing stores in the cluster. In some examples, the system can provide recommendations for a first store with a high waste risk score in a first cluster based on a second store with a low waste risk score in a second cluster, e.g. because the two stores have one common characteristic or because the two stores were in a same cluster in a previous clustering operation.

In some embodiments, the system provides recommendations that can provide strong conclusions on the potential impact of taking certain actions using causal inference techniques, e.g. using the causal graph 600 shown in FIG. 6. In the above example shown in FIG. 6, to get the treatment effect of the number of items markdown closer to expiry on CVP sales, effect of CVP coverage (a confounder) should be removed. According, a machine learning model is applied at operation 740 in FIG. 7 to handle this challenge.

In some embodiments, the machine learning model used at the operation 740 is a causal machine learning model, e.g. a double debiased machine learning model, that can capture non-linear effects. The system can remove the biased effect of a confounder (e.g. CVP coverage) on treatment (e.g. items markdown closer to expiry) and denoise the effect of the confounder on the outcome (e.g. CVP sales).

In some embodiments, these effects can be modeled using any machine learning model to generate residuals by removing the confounder effects. At operation 750, the residuals from the above models can be used to estimate the causal effect of the treatment on outcome. In some embodiments, various experiments are simulated to predict how the outcome variable varies under different treatment levels.

At operation 760, the system generates recommendation data based on multiple treatment variables. The recommendation data is ranked and prioritized at operation 770 to show the recommended actions with most potential in terms of lift in KPIs and/or dollar value.

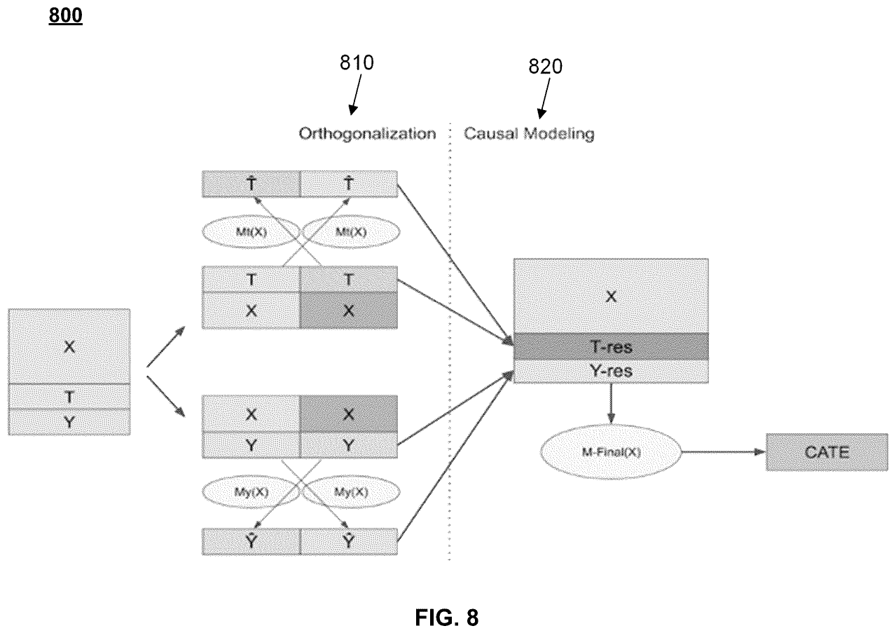

FIG. 8 illustrates an exemplary causal machine learning model 800, in accordance with some embodiments of the present teaching. In some embodiments, the causal machine learning model 800 may be utilized during the operations 740, 750 in FIG. 7.

As shown in FIG. 8, the causal machine learning model 800 is a double debiased machine learning model comprising an orthogonalization section 810 and a causal modeling section 820. In the example shown in FIG. 8, the causal machine learning model 800 is used to generate residuals T-res and Y-res by removing confounder effects. To be specific, the causal machine learning model 800 is used to model (Y−My(Y|X)) and (T−Mt(T|X)), where Y represents waste KPIs, T represents key waste drivers, X represents confounding features, My represents a machine learning model estimating Y using X, Mt represents a machine learning model estimating T using X.

In some embodiment, once the disclosed solution is launched in production and scaled to a few stores, the system can collect and measure the effectiveness of recommended actions through implicit and/or explicit feedback on whether the insight was helpful and whether the associates performed the recommended actions. This additional layer of feedback loop is used to design a reinforcement learning agent that can learn the environment better and update the reward function to maximize the overall utility and provide an optimal policy of what actions are to be taken through an iterative learning process.

In some embodiment, the insights and recommendations based on the disclosed framework are generated at a set frequency, e.g. daily or weekly. The insights and recommendations are consumed by the store associates, store managers, regional and category managers, by navigating to the insights page on the UI dashboard. Alternatively or additionally, the insights and recommendations are sent as alerts or notifications on mobile devices to the associates working in stores through a mini app or retailer app. All authorized store users can have access to this application and can view, perform, and provide feedback on the suggested actions.

As such, the disclosed framework combines and uses the results from one step in the machine learning pipeline for the next step. The disclosed framework helps answering questions about what, where, why, and what actions to take next, with a goal to optimize and reduce waste. For example, an anomaly detection engine runs every week to provide the insight into the most concerning behavior for any store-department items, e.g. a department in a store has the highest waste percentage in last 4 weeks and drop in CVP percentage by 30%. A drill-down of this output based on the disclosed method can show where this behavior is arising from (e.g. what fine lines or items in the department contributed the most to this behavior). Potential reasons or actions that resulted in this anomalous behavior is also provided to the store associates. For example, items are being thrown away either without applying CVP markdown or unoptimized markdown activity and losing out on CVP sales; overproducing items than the forecasted demand leading to waste, etc.

In some embodiments, to provide such detailed recommendations, stores are clustered into cohorts to arrive at homogenous groups that have similar characteristics and performances. Insights are further analyzed using causal discovery techniques which involve identifying the conditional dependency between various controllable treatments, confounders and outcome/target variables for each of the clusters separately. Once the causality is established, a causal machine learning model is leveraged to calculate the effect of the change in treatment on the outcome variable. The system can simulate various experiments based on the causal results to generate the potential impact of implementing various actions that influence waste and prioritize those actions to provide a unique way of offering pro-active recommended actions.

The disclosed system creates this seamless pipeline that scales across levels which ties together the learnings from various techniques used to provide pro-active and informed actions to the associates to optimize waste. In addition, the system provides: automated identification and prioritization of stores, items, events that needs to action on waste; key driver analysis of waste identification across multitude signals across the product life cycle using advanced causal discovery; proactive notification of waste and lost profit opportunities; prescriptive recommendations to store associates to reduce waste and measuring impact of decisions; automated easy-to-interpret insights on waste metrics in interactive dashboards and associate device applications; improvised recommendations based on the actions implemented every week and explicit feedback collected from the users that gauge the utility of suggested actions and update the reward functions through a reinforcement learning framework.

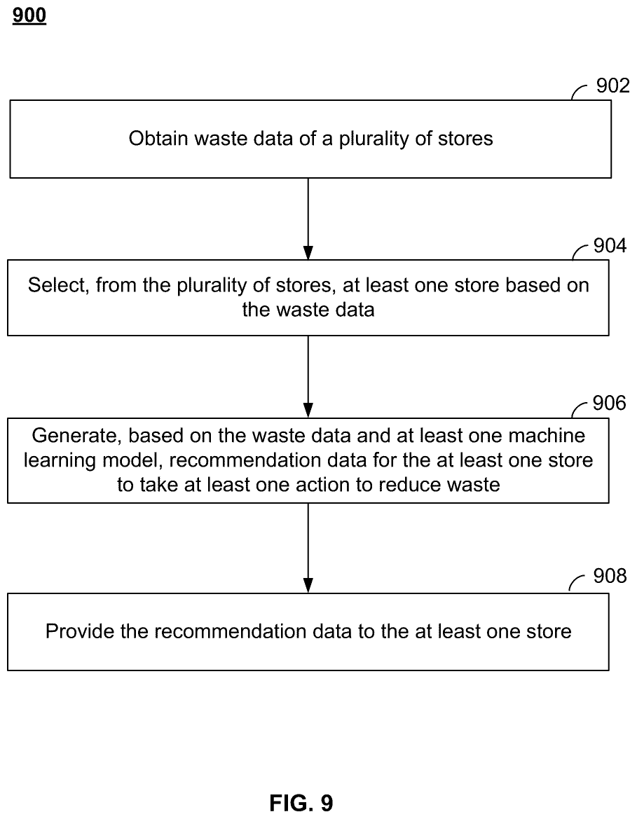

FIG. 9 shows a flowchart illustrating an exemplary method 900 for generating insights and recommendations to reduce waste in retail stores, in accordance with some embodiments of the present teaching. In some embodiments, the method 900 can be carried out by one or more computing devices, such as the waste reduction computing device 102 and/or the cloud-based engine 121 of FIG. 1. Beginning at operation 902, obtain waste data of a plurality of stores are obtained. At operation 904, at least one store is selected from the plurality of stores based on the waste data. At operation 906, based on the waste data and at least one machine learning model, recommendation data is generated for the at least one store to take at least one action to reduce waste. At operation 908, the recommendation data is provided to the at least one store.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain waste data of a plurality of stores,
select, from the plurality of stores, at least one store based on the waste data,
generate, based on the waste data and at least one machine learning model, recommendation data for the at least one store to take at least one action to reduce waste, and
provide the recommendation data to the at least one store.

2. The system of claim 1, wherein:
the plurality of stores are associated with a same retailer;
the waste data includes a plurality of measurements related to waste management and markdown efficiency at each of the plurality of stores; and
the at least one processor is configured to present the waste data of the plurality of stores via a user interface to associates of the plurality of stores.

3. The system of claim 2, wherein the at least one store is selected based on:
selecting, from the plurality of stores, a subset of stores based on the waste data;
generating insight data based on the waste data; and
selecting, from the subset of stores, the at least one store based on the insight data.

4. The system of claim 3, wherein selecting the subset of stores comprises:
computing a weight for each respective measurement of the plurality of measurements based on a function of variance of a distribution of the respective measurement in historical data;
computing a waste risk score for each respective store of the plurality of stores based on a weighted combination of the plurality of measurements at the respective store, using the computed weights for the plurality of measurements;
ranking the plurality of stores based on their respective waste risk scores; and
selecting, from the plurality of stores, the subset of stores having highest waste risk scores based on the ranking.

5. The system of claim 3, wherein generating the insight data comprises:
determining waste features and markdown features of the plurality of stores both at a store level and at an item level;
applying a first machine learning model to the waste features and the markdown features at the store level to identify a first set of anomalous stores;
applying the first machine learning model to the waste features and the markdown features at the item level to identify anomalous items in the first set of anomalous stores;
applying a second machine learning model to the waste data to identify a second set of anomalous stores and anomalous items in the second set of anomalous stores, based on trends in the waste data over a time period; and
generating the insight data based on results from the first machine learning model and the second machine learning model.

6. The system of claim 5, wherein selecting the at least one store comprises:
selecting the at least one store based on an intersection of: the subset of stores, the first set of anomalous stores and the second set of anomalous stores.

7. The system of claim 5, wherein the at least one processor is configured to:
rank the insight data based on monetary value lost associated with the results from the first machine learning model and the second machine learning model; and
present the ranked insight data via the user interface to associates of the plurality of stores.

8. The system of claim 4, wherein the recommendation data is generated based on:
clustering the plurality of stores into a plurality of clusters based on store related characteristics and performances, each cluster including stores having similar characteristics and performances to each other; and
for each cluster:
computing a distribution of the stores in the cluster based on waste risk scores,
identifying a first list of stores having top waste risk scores in the cluster,
identifying a second list of stores having top performances in the cluster, and
generating the recommendation data for the first list of stores based on at least one action taken by the second list of stores.

9. The system of claim 1, wherein the recommendation data is generated based on:
creating a causal graph based on the waste data to show a relationship between known treatment variables, outcome variables, and confounding variables related to waste management and markdown efficiency; and
inputting the causal graph to a causal machine learning model to determine key waste drivers and generate the recommendation data based on the key waste drivers.

10. The system of claim 1, wherein:
the recommendation data indicates the at least one store to take the at least one action at a store level, a department level, a category level, and/or an item level; and
the recommendation data is presented to associates of the at least one store via a webpage, a user interface, alerts and/or notifications.

11. The system of claim 10, wherein the at least one processor is configured to:
obtain feedback from the associates of the at least one store regarding effectiveness of the at least one action for waste reduction;
update, based on the feedback, a reward function for an agent in a reinforcement learning model to learn optimized actions through an iterative learning process;
generate updated recommendation data based on the optimized actions; and
provide the updated recommendation data to the at least one store.

12. A computer-implemented method, comprising:
obtaining waste data of a plurality of stores;
selecting, from the plurality of stores, at least one store based on the waste data;
generating, based on the waste data and at least one machine learning model, recommendation data for the at least one store to take at least one action to reduce waste; and
providing the recommendation data to the at least one store.

13. The computer-implemented method of claim 12, wherein:
the plurality of stores are associated with a same retailer;
the waste data includes a plurality of measurements related to waste management and markdown efficiency at each of the plurality of stores; and
the at least one processor is configured to present the waste data of the plurality of stores via a user interface to associates of the plurality of stores.

14. The computer-implemented method of claim 13, wherein selecting the at least one store comprises:
selecting, from the plurality of stores, a subset of stores based on the waste data;
generating insight data based on the waste data; and
selecting, from the subset of stores, the at least one store based on the insight data.

15. The computer-implemented method of claim 14, wherein selecting the subset of stores comprises:
computing a weight for each respective measurement of the plurality of measurements based on a function of variance of a distribution of the respective measurement in historical data;
computing a waste risk score for each respective store of the plurality of stores based on a weighted combination of the plurality of measurements at the respective store, using the computed weights for the plurality of measurements;
ranking the plurality of stores based on their respective waste risk scores; and
selecting, from the plurality of stores, the subset of stores having highest waste risk scores based on the ranking.

16. The computer-implemented method of claim 14, wherein generating the insight data comprises:
determining waste features and markdown features of the plurality of stores both at a store level and at an item level;
applying a first machine learning model to the waste features and the markdown features at the store level to identify a first set of anomalous stores;
applying the first machine learning model to the waste features and the markdown features at the item level to identify anomalous items in the first set of anomalous stores;
applying a second machine learning model to the waste data to identify a second set of anomalous stores and anomalous items in the second set of anomalous stores, based on trends in the waste data over a time period; and
generating the insight data based on results from the first machine learning model and the second machine learning model.

17. The computer-implemented method of claim 16, wherein the at least one processor is configured to:
rank the insight data based on monetary value lost associated with the results from the first machine learning model and the second machine learning model; and
present the ranked insight data via the user interface to associates of the plurality of stores.

18. The computer-implemented method of claim 15, wherein the recommendation data is generated based on:
clustering the plurality of stores into a plurality of clusters based on store related characteristics and performances, each cluster including stores having similar characteristics and performances to each other; and
for each cluster:
computing a distribution of the stores in the cluster based on waste risk scores,
identifying a first list of stores having top waste risk scores in the cluster,
identifying a second list of stores having top performances in the cluster, and
generating the recommendation data for the first list of stores based on at least one action taken by the second list of stores.

19. The computer-implemented method of claim 12, wherein generating the recommendation data comprises:
creating a causal graph based on the waste data to show a relationship between known treatment variables, outcome variables, and confounding variables related to waste management and markdown efficiency; and
inputting the causal graph to a causal machine learning model to determine key waste drivers and generate the recommendation data based on the key waste drivers.

20. A non-transitory computer readable medium having instructions stored thereon, wherein the instructions, when executed by at least one processor, cause at least one device to perform operations comprising:
obtaining waste data of a plurality of stores;
selecting, from the plurality of stores, at least one store based on the waste data;
generating, based on the waste data and at least one machine learning model, recommendation data for the at least one store to take at least one action to reduce waste; and
providing the recommendation data to the at least one store.
